(19) United States
(12) Patent Application Publication
(10) Pub. No.: US 2016/0314644 A1
(43) Pub. Date: Oct. 27, 2016

(54) Electronic Gaming Machine and Gaming Method

(71) Applicant: Ainsworth Game Technology Limited, Newington (AU)

(72) Inventors: Jason Meyer, Abbotsford (AU); Edgar Pau, North Ryde (AU)

(21) Appl. No.: 14/738,793

(22) Filed: Jun. 12, 2015

(30) Foreign Application Priority Data
Apr. 22, 2015 (AU) 2015202069

(51) Int. Cl. G07F 17/32; G07F 17/34; A63F 9/24

(52) U.S. Cl. CPC G07F 17/3213; A63F 9/24; G07F 17/3258; G07F 17/34; A63F 2009/2457

(57) ABSTRACT

An electronic gaming machine comprises a display for displaying a game and an electronic game controller for controlling the display of game symbols on the display. The electronic game controller enables the player to select a bet option from a plurality of bet options. Two or more bet options are associated with a combination of two or more unique game symbols and at least two bet options are associated with different combinations of said unique game symbols. In response to a player selecting one of the associated bet options, the electronic gaming machine awards a prize for said combination of said two or more game symbols associated with said selected bet option when said combination appears in a play of said game. A gaming method is also provided.

### BACKGROUND

The present invention relates to an electronic gaming machine and in a particular an electronic gaming machine using a base game and a feature game. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. This means that the feature game is restricted by the same set of rules, and so there is no variation in the play of the feature game.

Also, electronic gaming machines can offer one or more bonus prizes to the player during play of the game. The most common type of bonus prize that is awarded by the electronic gaming machine is a jackpot prize, the main example of which is a progressive jackpot prize.

This standard structure to game play and bonus prizes limits the variation in the play of the electronic gaming machine. Consequently, it is difficult to retain player interest because there is no apparent incentive for the player to continue playing the same electronic gaming machine once the player becomes familiar with the feature game, the main game and any bonus prizes. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

### SUMMARY

According to a first aspect of the invention, there is provided an electronic gaming machine comprising:

a display for displaying a game, wherein said game comprises game symbols arranged in an array of symbol positions and where predetermined winning combinations of randomly selected game symbols award prizes to a player; and

an electronic game controller for controlling the display of said game symbols on said display;

wherein said electronic game controller enables said player to select a bet option from a plurality of bet options for said game, two or more of said bet option being associated with a combination of two or more unique game symbols and at least two bet options being associated with different combinations of said two or more unique game symbols; and

wherein said player selects one of said associated bet options and, in response to said selection, said electronic gaming machine awards a prize for said combination of said two or more unique game symbols associated with said selected bet option when said combination appears in a play of said game.

Preferably, said plurality of bet options further comprises a bet option that is not associated with a combination of two or more unique game symbols. Alternatively, an additional bet option to said plurality of bet options is provided, wherein said additional bet option is not associated with a combination of two or more unique game symbols.

Preferably, one of said associated bet options is associated with a combination of at least three unique game symbols.

Alternatively or additionally, one of said associated bet options is associated with a combination of at least four unique game symbols.

Alternatively or additionally, one of said associated bet options is associated with a combination of at least five unique game symbols.

Preferably, the number of unique game symbols in said combinations associated with said associated bet options increases as the value of the selected bet option increases.

Preferably, said game comprises a base game and a feature game, and prizes are awarded in said base game and said feature game for said combination of unique game symbols associated with said selected bet option.

Preferably, said unique game symbols in said combination associated with said selected bet option are dynamically shown on said display.

Preferably, said unique game symbols in said combination associated with said selected bet option are selectable by said player from a group of unique game symbols. More preferably, said unique game symbols available in said group depend on a bet per game value selected by said player. In one embodiment, said unique game symbols available in said group depend on the value of said selected bet option.

Preferably, one of said combinations of unique game symbols associated with at least one of said associated bet options is also associated with a jackpot prize awarded by said electronic gaming machine.

Preferably, said electronic gaming machine comprises a housing having said display and containing said electronic game controller.

Preferably, said electronic gaming machine comprises an input device. It is also preferred that said input device comprises one or more buttons on said housing, said buttons being in electronic communication with said electronic game controller to transmit player commands to said electronic game controller. More preferably, said buttons are arranged on a console of said housing. Alternatively or additionally, said input device comprises a touch sensitive surface on said display for receiving player commands, said touch sensitive surface being in electronic communication with said electronic game controller to transmit player commands to said electronic game controller.

Preferably, said electronic gaming machine comprises a value transfer mechanism for paying said prizes to said player using value in an amount equal to an awarded prize. Alternatively or additionally, said value transfer mechanism receives value from said player to make said bet and initiate play of said game. More preferably, said value transfer mechanism is in electronic communication with said electronic game controller. It is also preferred that said value transfer mechanism is provided on said housing. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means money denominations, credits, gaming tokens, coins, paper, currency, tickets, vouchers (both physical and electronic), credit cards, debit cards, smart cards, memory devices capable of storing value and any other object representative of value.

Preferably, said array has rectangular, circular, triangular, oval, semi-circular or other non-rectangular shape.

Preferably, said game comprises a feature game. Alternatively, said game comprises a base game. In a further alternative, said game comprises a base game and a feature game, wherein said game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to a trigger event in said base game. Alternatively, said electronic game controller causes the display of said feature game and said base game during play of said base game, said feature game being inactive until triggered. In this embodiment, the change in said feature game from being inactive to active may be indicated on the display. This indication may be visual, aural or a combination of both.

Preferably, said array comprises one or more rows and/or columns of said symbol positions. In one embodiment, said array comprises a plurality of reels. Preferably, the player selectively starts and/or stops play of said reels in said game array and/or said reels in said feature game.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

A second aspect of the present invention provides an electronic gaming machine comprising:

a display for displaying game symbols for playing a game, wherein said game comprises randomly displaying said game symbols in an array of symbol positions and awarding prizes to a player for predetermined winning combinations of game symbols to a player;

an electronic game controller in electronic communication with said display for controlling the appearance of game symbols in said game on the display; and

a value transfer mechanism for receiving value from a player to make a bet and initiate play of said game on said display, said value transfer mechanism being in electronic communication with said electronic game controller;

wherein said electronic game controller in response to said player making a bet via said value transfer mechanism commences play of said game by randomly selecting game symbols and transmitting a signal to said display to display said randomly selected game symbols;

wherein electronic gaming machine enables said player to select a bet option from a plurality of bet options for said game, two or more of said bet options being associated with a combination of two or more unique game symbols and at least two bet options being associated with different combinations of said unique game symbols; and

wherein said player selects one of said associated bet options and, in response to said selection, said electronic gaming machine awards a prize for said combination of said two or more game symbols associated with said selected bet option when said combination appears in a play of said game.

This second aspect of the invention preferably has the preferred features of the first aspect of the invention stated above, where applicable.

According to a third aspect of the invention, there is provided a gaming method for an electronic gaming machine comprising a display and an electronic game controller, the method comprising the steps of:

controllably displaying game symbols for playing a game, wherein said game comprises game symbols arranged in an array of symbol positions and predetermined winning combinations of randomly selected game symbols award prizes to a player;

enabling said player to select a bet option from a plurality of bet options for said game;

associating two or more of said bet options with a combination of two or more unique game symbols;

associating at least two bet options with different combinations of said unique game symbols; and

in response to said player selecting one of said associated bet options, enabling said electronic gaming machine to award a prize for said combination of said two or more unique game symbols associated with said selected bet option when said combination appears in a play of said game.

Preferably, said method comprises providing a bet option that is not associated with a combination of two or more unique game symbols. Alternatively said method comprises providing an additional bet option to said plurality of bet options, wherein said additional bet option is not associated with a combination of two or more unique game symbols.

Preferably, said associating step comprises associating one of said bet options with a combination of at least three unique game symbols.

Alternatively or additionally, said associating step comprises associating one of said bet options with a combination of at least four unique game symbols.

Alternatively or additionally, said associating step comprises associating one of said bet options with a combination of at least five unique game symbols.

Preferably, said method comprises increasing the number of unique game symbols in said combinations associated with said associated bet options as the value of the selected bet option increases.

Preferably, said game comprises a base game and a feature game, and said enabling step comprises awarding prizes in said base game and said feature game for said combination of unique game symbols associated with said selected bet option.

Preferably, said method comprises dynamically showing said unique game symbols in said combination associated with said selected bet option on said display.

Preferably, said method comprises selecting said unique game symbols in said combination associated with said selected bet option from a group of unique game symbols. More preferably, said method comprises making said unique game symbols available in said group dependent on a bet per game value selected by said player. In one embodiment, said method comprises making said unique game symbols available in said group dependent on the value of said selected bet option.

Preferably, said method comprises associating one of said combinations of unique game symbols, associated with at least one of said associated bet options, with a jackpot prize awarded by said electronic gaming machine.

Preferably, said method comprises displaying said array in a rectangular, circular, triangular, oval, semi-circular or other non-rectangular shape.

Preferably, said game comprises a feature game. Alternatively, said game comprises a base game. In a further alternative, said game comprises a base game and a feature game, said method comprising arranging said game symbols in said feature game and said base game in arrays of the same shape or type. Alternatively, said method comprises arranging said game symbols in said feature game and said base game in differently shaped arrays.

Preferably, said method comprises displaying said feature game in response to a trigger event in said base game. Alternatively, said method comprises displaying said feature game and said base game during play of said base game, said feature game being inactive until triggered. In this embodiment, said method comprises indicating on said display the change in said feature game from being inactive to active. This indication may be visual, aural or a combination of both.

Preferably, said method comprises arranging said array into one or more rows and/or columns of said symbol positions. In one embodiment, said method comprises arranging said array into a plurality of reels. Preferably, said method comprises enabling said player to selectively start and/or stop play of said reels in said array.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

The method preferably has the preferred features of the first aspect of the invention where applicable.

A fourth aspect of the present invention provides a gaming method for an electronic gaming machine comprising a display for displaying a game, wherein said game comprises game symbols arranged in an array of symbol positions and predetermined winning combinations of randomly selected game symbols in said game award prizes to a player; an electronic game controller for controlling the display of said game symbols for playing said game on said display; and a value transfer mechanism for receiving value from a player to make a bet and initiate play of said game on said display, said value transfer mechanism being in electronic communication with said electronic game controller, the, the method comprising:

said electronic gaming machine receiving a bet from said player via said value transfer mechanism to initiate play of said game on said display;

said electronic game controller enabling said player to select a bet option from a plurality of bet options for said game;

said electronic game controller associating two or more of said bet options with a combination of two or more unique game symbols;

said electronic game controller associating at least two bet options with different combinations of said unique game symbols; and

said electronic game controller, in response to said player selecting one of said associated bet options, enabling said electronic gaming machine to award a prize for said combination of said two or more unique game symbols associated with said selected bet option when said combination appears in a play of said game.

The method of the fourth aspect of the invention preferably has the preferred features of the third aspect of the invention stated above, where applicable.

According to a fifth aspect of the invention, there is provided a computer system comprising a central processing unit configured for communication with an electronic gaming machine, wherein said computer system is configured to perform the method of the third or fourth aspects of the invention.

According to a sixth aspect of the invention, there is provided a computer programme configured to perform the method of the third or fourth aspects of the invention.

According to a seventh aspect of the invention, there is provided a non-transitory carrier medium carrying computer executable code that, when executed on a central processing unit configured for communication with an electronic gaming machine, causes the central processing unit to perform the method of the third or fourth aspects of the invention.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1;

FIG. 3 is a simulated screen shot illustrating a base game played on the electronic gaming machine of FIG. 1;

FIG. 4 is a partial simulated screen shot illustrating an example of a table shown on the display of the electronic gaming machine of FIG. 1;

FIGS. 5 and 6 are simulated screen shots illustrating a feature game played on the display of the electronic gaming machine of FIG. 1;

FIG. 7 is a simulated screen shot illustrating a base game played on the display of the electronic gaming machine of FIG. 1;

FIG. 8 is a simulated screen shot illustrating a selection screen enabling selection of a bet option, shown on the display of the electronic gaming machine of FIG. 1;

FIG. 9 is a perspective view of an electronic gaming machine according to another embodiment of the invention;

FIG. 10 is a schematic drawing of a control panel for the electronic gaming machine of FIG. 9; and

FIG. 11 is a block diagram of the electronic components of the electronic gaming machine of FIG. 9.

### DETAILED DESCRIPTION OF VARIOUS EMBODIMENTS

The present invention will now be described with reference to the following examples which should be considered in all respects as illustrative and non-restrictive. In the Figures, corresponding features within the same embodiment or common to different embodiments have been given the same reference numerals.

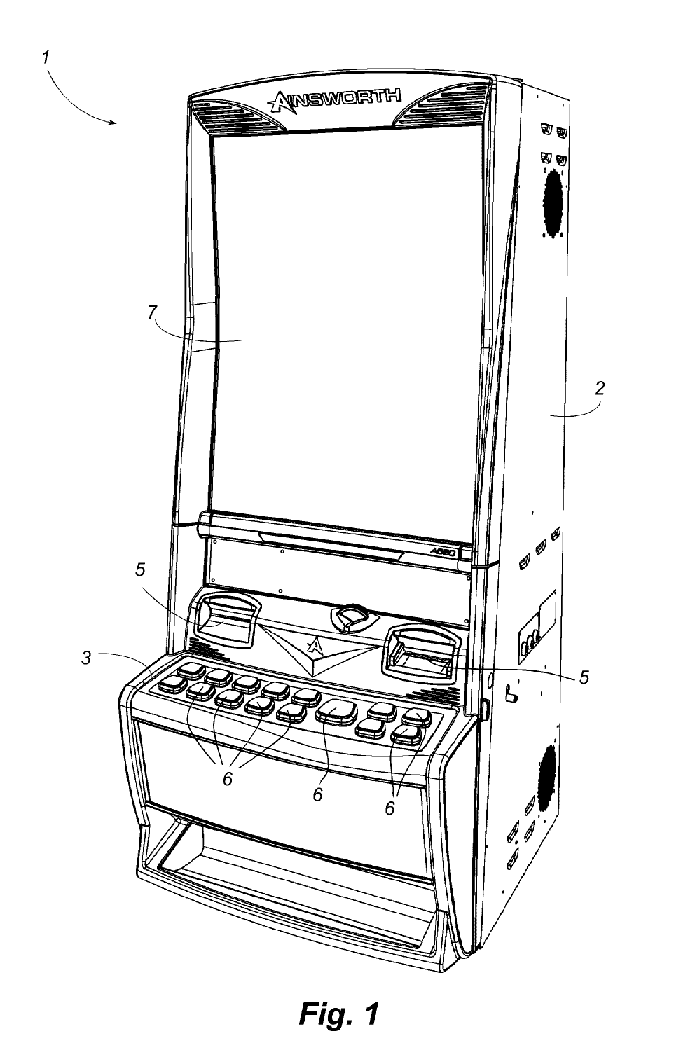

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

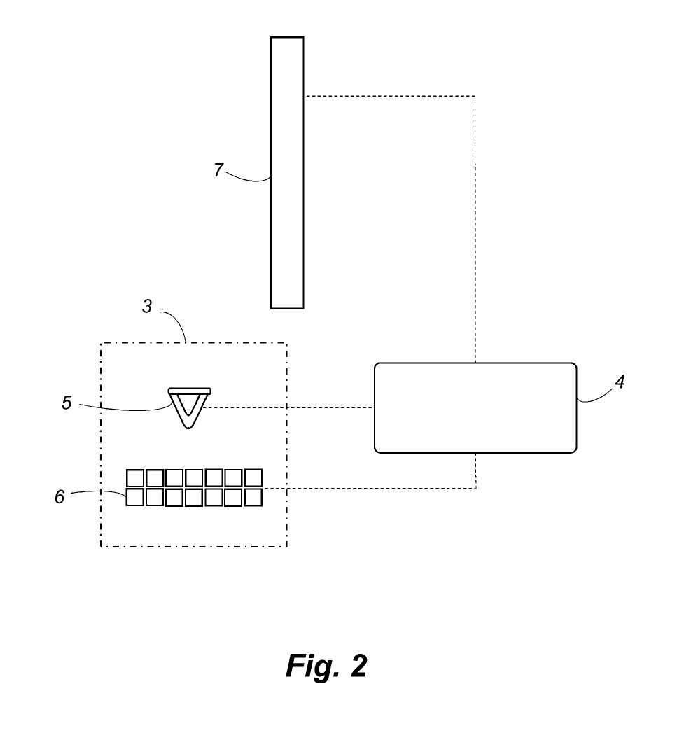

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store programme instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1.

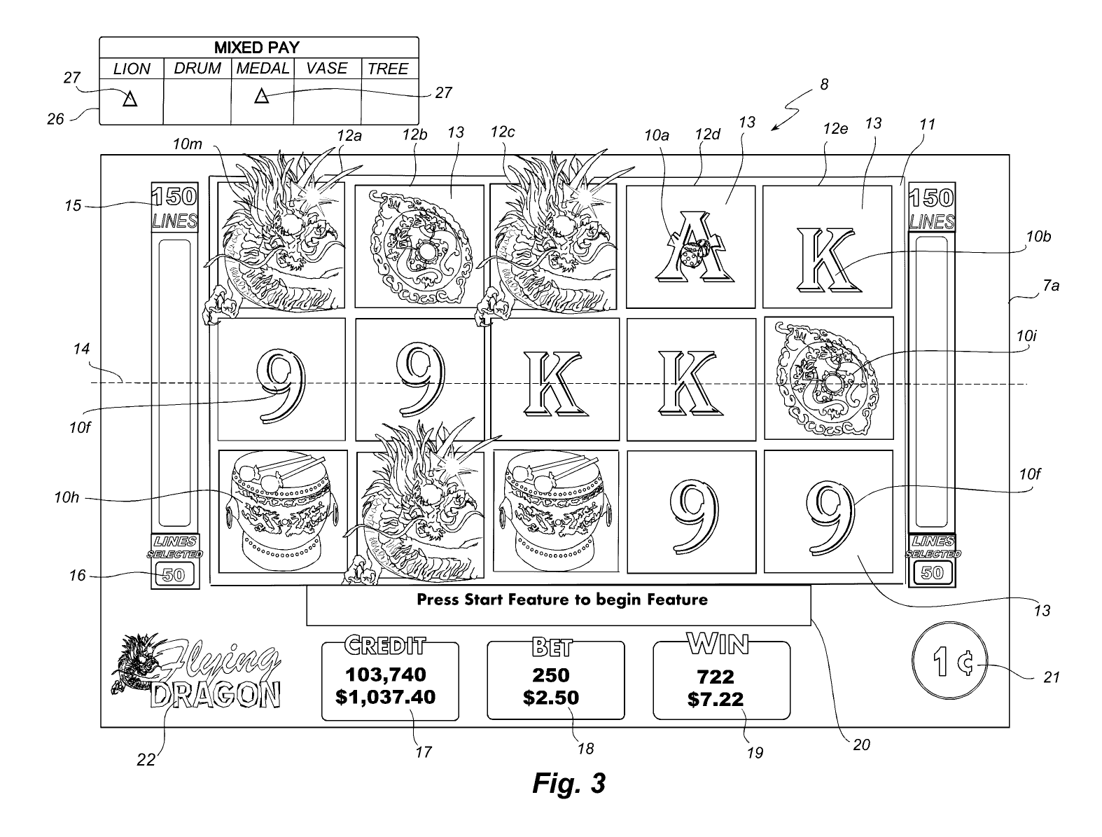

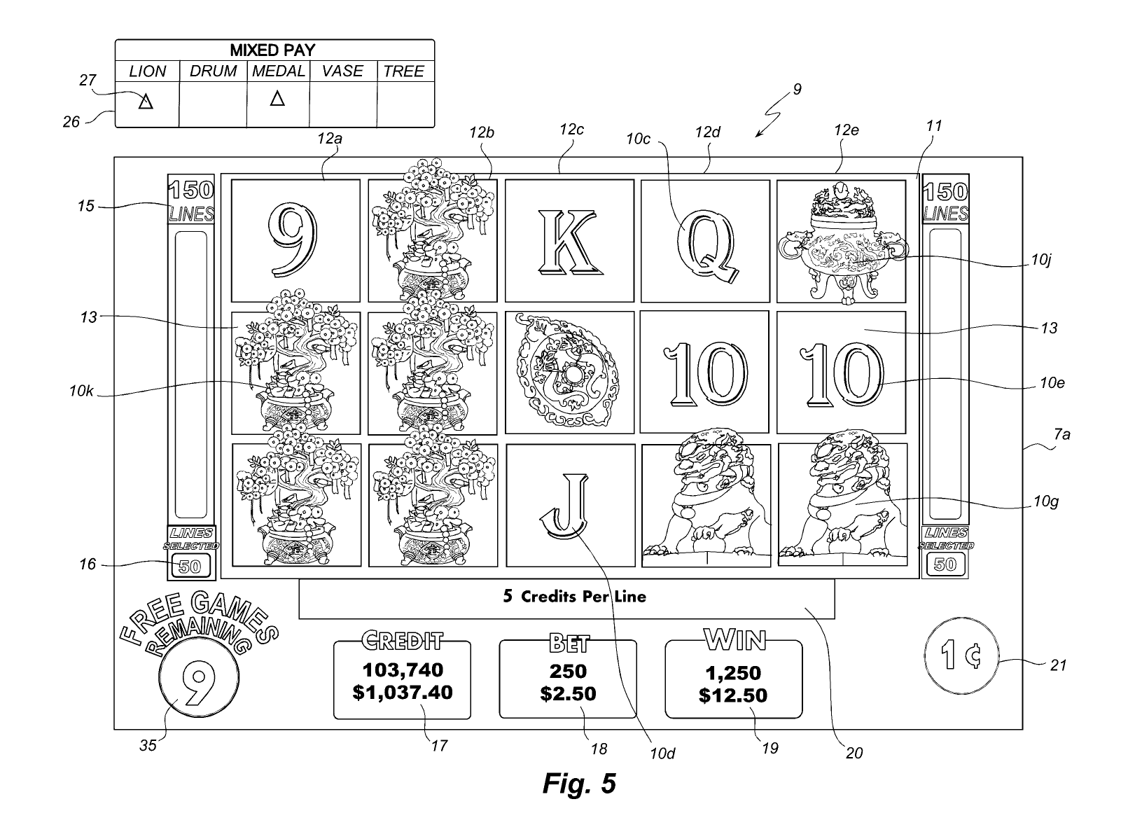

The electronic game controller 4 is programmed to provide a game in the form of a base game 8 (as best shown in FIG. 3) and a feature game 9 (as best shown in FIG. 5) on a lower display area 7a of the display 7 of the electronic gaming machine 1 for play by a player. The base game 8 has game symbols 10 arranged into an array 11 in the form of five columns or “reels” 12a, 12b, 12c, 12d and 12e. The reels 12a, 12b, 12c, 12d and 12e give the visual appearance of rotating, typically by having the game symbols 10 move in a downward linear path along the length of each reel 12a, 12b, 12c, 12d and 12e. The array 11 is arranged with five reels 12a, 12b, 12c, 12d and 12e and three rows as per the industry standard, it will be appreciated by one skilled in the art that other types of arrays could be used, such as 3×3, 4×3, 5×5, 4×4, etc, including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower display area 7a, including showing the game symbols 10, array 11 and other visible elements of the games.

The array 11 of the base game 8 defines predetermined symbol positions 13, in which the game symbols 10 appear. In this embodiment, the symbol positions 13 are visually marked by boundary lines to define “squares” or “cells”. However, it will be appreciated that in other embodiments, the symbol positions 13 are not defined by any visible boundary lines and simply provide an area for the game symbols 10 to appear. In yet other embodiments, other markings can be used to define each respective area of the symbol positions 13 or game positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event (like activating a feature game) or confers an award, where the trigger symbol may or may not have to appear in combination and may or may not have to appear on the same player-selected pay line 14. In this embodiment, the game symbols 10 include playing card symbols “A” (ace) 10a, “K” (king) 10b, “Q” (queen) 10c, “J” (jack) 10d, “10” 10e and “9” 10e; picture symbols “lion” 10g, “drum” 10h, “medal” 10i, “vase” 10j, “tree” 10k and “coin” 10l; and a substitute or wild card symbol in the form of “Dragon” symbol 10m. In this embodiment, the Dragon symbol 10m also acts as a scatter symbol that triggers the feature game 9. The electronic game controller 4 randomly determines the appearance of the game symbols 10 on the array 11.

The lower display area 7a also displays other standard game information including the number of pay lines available 15, the number of player-selected pay lines 16, the amount of player credits 17, the amount of the current bet wagered by the player 18, the amount of wins by the player 19, a message area 20, a current denomination button 21 indicating the currently selected base bet denomination and the name of the game 22 “Flying Dragon”™. Other standard information may also include a menu button (not shown) for bringing up a menu screen (not shown).

An upper display area (not shown) of the video screen 7 may display an animated title or feature screen for the game and/or information relating to the rules for the base game 8 and feature game 9 discussed below. This includes information outlining the key characteristics of the base game 8 and feature game 9. In other embodiments, the upper display area displays jackpot information relating to the base game 8 and/or feature game 9 that are awarded by the electronic gaming machine 1. This jackpot information can comprise, in descending order of monetary value, a grand jackpot, major jackpot, minor jackpot and midi jackpot.

The player initially makes a bet using vending slots 5 initiate play of the electronic gaming machine 1 to build up credit to play the base game 8 on the electronic gaming machine. For example, the player can bet or wager monetary amounts equivalent to a particular amount of credits, depending on the bet denomination selected for the base game. Also, the player can make any additional side bets or ante-bets during play of the base game once the game has commenced to access additional features in the game, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc. In this embodiment, five bet options are offered by the electronic gaming machine 1 via the menu screen 25—a bet of 75 credits, 150 credits, 225 credits, 300 credits and 375 credits. The bet option selected determines the number of pay lines 14 that become payable in the base game 8. The bet option of 75 credits permits the player to play 25 pay lines, the bet option of 150 credits permits the player to play 50 pay lines, the bet option of 225 credits permits the player to play 75 pay lines, the bet option of 300 credits permits the player to play 100 pay lines and the bet option of 375 credits permits the player to play 150 pay lines.

The selected bet option also determines whether there are any combinations of game symbols in addition to the standard combinations of game symbols, such as three of a kind, four of a kind and five of a kind (with or without the substitute Dragon symbol 10m), that will award a prize to the player when appearing on the player-selected pay lines 14. In this embodiment, the bet option of 150 credits results in the award of a prize to the player where there is a combination of two unique or different picture symbols in a group of three, four or five on a player-selected pay line 14. For example, the two picture symbols may be the lion symbol 10g and the medal symbol 10i so that any combination of three, four or five of these symbols on a player-selected pay line 14 will confer a prize on the player. In this example, the prize winning combinations of mixed game symbols would be a group of three corresponding to a three of a kind (two lion symbols 10g and one medal symbol 10i or one lion symbol 10g and two medal symbols 10i), a group of four corresponding to a four of a kind (three lion symbols 10g and one medal symbol 10i, two lion symbols 10g and two medal symbols 10i, or one lion symbol 10g and three medal symbols 10i) and a group of five corresponding to a five of a kind (four lion symbols 10g and one medal symbol 10i, three lion symbols 10g and two medal symbols 10i, two lion symbols 10g and three medal symbols 10i, or one lion symbol 10g and four medal symbols 10i).

Similar prize winning combinations are awarded by selecting bet options 225, 300 credits and 375 credits, but the number of different game symbols that can form the combination of mixed game symbols increases. Hence, the bet option of 225 credits will grant a prize upon the player for combinations of three unique or different game symbols (say, the lion symbol 10g, the drum symbol 10h and the medal symbol 10i) in groups of three, four or five; the bet option of 300 credits will grant a prize upon the player for combinations of four unique or different game symbols (say, the lion symbol 10g, the drum symbol 10h, the medal symbol 10i and the vase symbol 10j) in groups of three, four or five; and the bet option of 375 credits will grant a prize upon the player for combinations of five unique or different game symbols (say, the lion symbol 10g, the drum symbol 10h, the medal symbol 10i, the vase symbol 10j and the tree symbol 10k) in groups of three, four or five.

As more unique game symbols become available in a mixed combination of game symbols, there is an increased number of possible winning combinations using a mixture of unique game symbols, and thus a greater chance of the player winning a prize during play of the base game 8. For example, the bet option of 225 credits will provide additional mixed combinations compared with the bet option of 150 credits, such as one lion symbol 10g, one drum symbol 10h and one medal symbol 10i, two drum symbols 10h and one lion symbol 10g or medal symbol 10i, two lion symbols 10g and one drum symbol 10h, and two medal symbols 10i and one drum symbol 10h for a group of three mixed combination.

As briefly discussed and illustrated above in relation to a group of three, the combinations of unique game symbols (which for ease of reference will referred to hereinafter as a “mixed combination”) refers to any combination of the unique game symbols 10g to 10k that are designated in the mixed combination which form the stated group of three, four or five. That is, a winning mixed combination of a group of four (equivalent to a four of a kind) is obtained for any four game symbols in the same pay line 14 that belong to the designated game symbols based on the selected bet option, and so comprises groupings of those designated game symbols, which may or may not omit one or more of those designated game symbols. For example, the bet option of 225 credits designates the lion symbol 10g, the drum symbol 10h and the medal symbol 10i as forming a winning mixed combination. Possible mixed combinations would thus include the lion symbol-based combinations of one lion symbol 10g and two drum symbols 10h or two medal symbols 10i; two lion symbols 10g and one drum symbol 10h or one medal symbol 10i; and one of each of the lion symbol 10g, the drum symbol 10h and the medal symbol 10i. Hence, the drum symbol 10h or the medal symbol 10i is omitted from some of the mixed combinations. Other possible mixed combinations would include combinations based on the drum symbol 10 and the medal symbol 10i on the same lines as the lion-symbol based combinations (leaving out duplicated combinations) that can omit the lion symbol 10g.

Likewise, a mixed combination of a group of four (equivalent to a four of a kind) is obtained for any four game symbols in the same pay line 14 that are the designated game symbols based on the selected bet option. For example, the bet option of 300 credits designates the lion symbol 10g, the drum symbol 10h, the medal symbol 10i and vase symbol 10j as forming a mixed combination. The possible mixed combinations thus comprise the lion symbol-based combinations of one lion symbol 10g and three drum symbols 10h, three medal symbols 10i or three vase symbols 10i; two lion symbols 10g and two of the drum symbol 10h, medal symbol 10i and vase symbol 10j; three lion symbols 10g and one of the drum symbol 10h, medal symbol 10i and vase symbol 10j. Again, the drum symbol 10h and/or the medal symbol 10i are omitted from some of the mixed combinations, as well as the vase symbol 10j. Other possible mixed combinations for a group of four comprise combinations based on the drum symbol 10, the medal symbol 10i and the vase symbol 10j on the same lines as the lion-symbol based combinations (leaving out duplicated combinations), some of which do not have the lion symbol 10g or one or more of the other symbols.

Also, a winning mixed combination of a group of five (equivalent to a five of a kind) is obtained for any five game symbols in the same pay line 14 that are the designated game symbols based on the selected bet option, and so comprises combinations based on each of the designated game symbols For example, the bet option of 375 credits designates the lion symbol 10g, the drum symbol 10h, the medal symbol 10i, vase symbol 10j and the tree symbol 10k as forming a winning mixed combination. The possible mixed combinations thus comprise the lion symbol-based combinations of one lion symbol 10g and four symbols selected from the drum symbol 10h, medal symbol 10i, vase symbol 10i and the tree symbol 10k (such as four drum symbols 10h, three drum symbols 10h and one of the medal, vase or tree symbols, two drum symbols and two of the medal, vase or tree symbols, one of each of the drum, medal, vase and tree symbols, etc.); two lion symbols 10g and three symbols selected from the drum symbol 10h, medal symbol 10i, vase symbol 10i and tree symbol 10k; three lion symbols 10g and two symbols selected from the drum symbol 10h, medal symbol 10i, vase symbol 10j and tree symbol 10k; four lion symbols 10g and one of the drum symbol 10h, medal symbol 10i, vase symbol 10j or tree symbol 10k. Thus, it can be seen that the drum symbol 10h, the medal symbol 10i, vase symbol 10j and/or tree symbol 10k are omitted from some of the mixed combinations. Other possible mixed combinations for a group of five comprise combinations based on the drum symbol 10, the medal symbol 10i, the vase symbol 10j and the tree symbol 10k on the same lines as the lion-symbol based combinations (leaving out duplicated combinations), some of which do not have the lion symbol 10g or one or more of the other symbols.

The mixed combinations of unique game symbols are also augmented by the substitute Dragon symbol 10m. Thus, a mixed combination can be formed using one or more substitute Dragon symbols 10m for one or more game symbols that form the mixed combination. Hence, a possible winning mixed combination of a group of four (obtained by selecting the 225 credits bet option) can comprise only one of each lion symbol 10g, drum symbol 10h and medal symbol 10i, but a Dragon symbol 10m is also present on the same pay line 14.

In this embodiment, the base or lowest bet option of 75 credits only provides the standard winning combinations and not any mixed combinations. This provides the player with an option not to play the game with the mixed combinations and instead play the base game 8 more conventionally.

It should also be noted that not all picture symbols are eligible to form a winning mixed combination, as picture symbol coin 10l shown in FIG. 6 is part of the base game 8 and feature game 9, but is not one of the game symbols 10 used in a mixed combination. The playing card symbols 10a to 10f also do not form part of a mixed combination. However, it will be appreciated that mixed combinations can be formed from any of the game symbols in the base game 8 and/or feature game 9.

Typically, the electronic gaming machine also has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game 8, which would be the 1¢ bet denomination for this embodiment. The player may change the bet denomination at any time in the base game 8 by touching the denomination button before or after the reels 12 have spun. In this embodiment, touching the denomination button 21 will bring denomination images that the player may select to quickly change the bet denomination between plays of the game 8.

Once the player has made a bet to commence play of the game 8, the electronic game controller 4 then transmits a signal to the display 7 to make reels 12 to appear to visibly rotate or “spin” in a linear path, typically in a downward vertical direction, and randomly display the game symbols 10 in each symbol position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10. Where playing card symbols are optionally used, other predetermined winning combinations include poker-based combinations of a “full house”, “straight” or “flush”. It will be appreciated that other winning combinations of game symbols 10 can also be provided. If so, the electronic gaming machine 1 enters a winning game state and awards a prize according to the displayed predetermined winning combination.

The electronic game controller 4 also assesses whether any winning mixed combinations also appear on the player-selected pay lines 14 where the player has selected one of the bet options that also provides a winning mixed combination. If so, the electronic gaming machine 1 enters a winning game state and awards a prize according to the displayed predetermined winning mixed combination as described above.

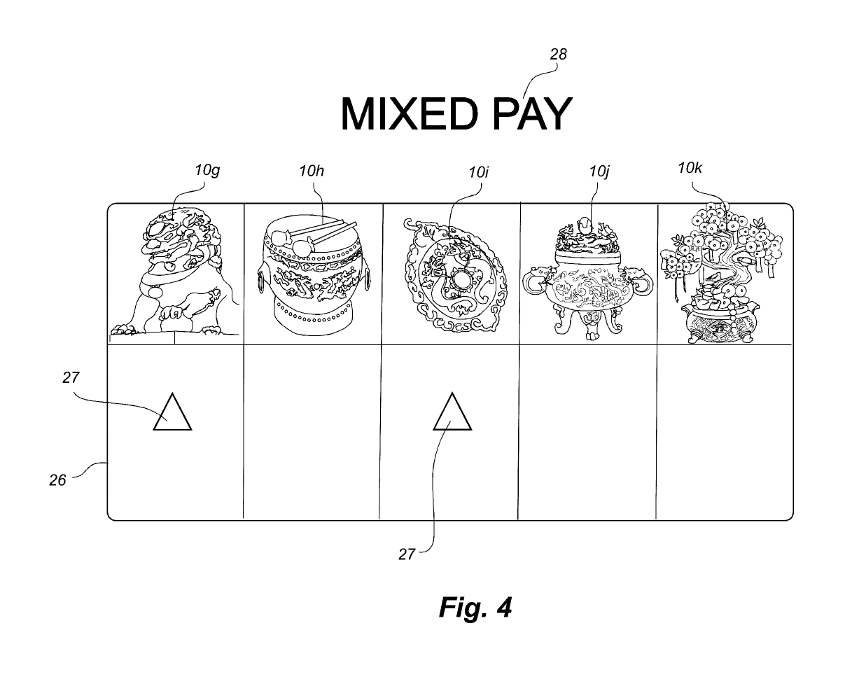

During play of the base game 8, the available winning mixed combinations are shown to the player just above the array 11 in an area that takes the form of a table 26, as best shown in FIG. 3. In table 26, each available game symbol for a mixed winning combination is shown by name and a visual indicator or marker (such as an arrowhead or triangle 27) indicates to the player which game symbols 10 can be used in a mixed combination of three, four or five game symbols to award a prize. Another example of the table 26 is shown in FIG. 4, where the actual available game symbols 10g to 10k for a mixed winning combination are shown in the table 26. In FIGS. 3 and 4, the bet option of 225 credits has been selected, enabling mixed combinations of the lion symbol 10g and the medal symbol 10i to award prizes to the player for any group of three, four or five lion symbols 10g and medal symbols 10i appearing on player-selected pay lines 14. The table 26 is also titled “Mixed Pay” at 28 to further inform the player the currently selected mixed combination of game symbols.

In addition, the electronic game controller 4 randomly determines whether a predetermined trigger event has occurred which triggers the feature game 9 on the electronic gaming machine 1. In this embodiment, the trigger event is the appearance of three Dragon symbols 10m anywhere on the reels 12 without having to be on a player-selected pay line 14; i.e. the Dragon symbols 10m act as scatter symbols in this instance. In response to this trigger event, the electronic game controller 4 then causes the feature game 9 to be shown on the lower display area 7a of the screen 7, as best shown in FIG. 5. However, it will be appreciated that in other embodiments, the feature game 9 is shown in the upper display area.

The feature game 9 uses the same array 11, reels 12a to 12e, game symbols 10, symbol positions 13 and pay lines 14 as in the base game 8. In the feature game 9, ten free plays or spins of the reels 12 are awarded to the player. It will be understood by those skilled in the art that a free spin involves a play of the game without requiring any bet to be made by the player, and that any number of free spins can be chosen for the feature game. In addition, it will be appreciated that in the art free spins are commonly referred to as “free games”. The number of free spins left in the feature game 9 is indicated in a counter 35. In FIG. 5, the first free spin has concluded and the counter 35 shows that nine free spins remain in the feature game 9.

Moreover, the mixed winning combinations that were available in the base game 8 due to the player's selected bet option are also made available in the feature game 9. Thus, as shown in FIG. 5, in the feature game 9 the table 26 of FIG. 4 appears in the same position above the array 11 as it appears in the base game 8 illustrated in FIG. 3. Consequently, the player retains the benefit of having an increased probability of achieving a winning combination in the feature game 9 based on the additional winning mixed combinations of the lion symbol 10g and the medal symbol 10i being available.

Referring to FIG. 6, where corresponding features have been given the same reference numerals, the next (second) free spin has concluded and the counter shows that eight free spins remain in the feature game 9. Also, a winning combination has appeared on the reels 12, which is shown by visibly highlighting the winning pay line 14 and identifying the winning pay line by its allocated number 36. The winning combination comprises two of the same coin game symbol 10l and two of the substitute Dragon symbols 10m to form a four of a kind. The substitute Dragon symbols 10m are animated when used in a winning combination. In this embodiment, the animation takes the form of the Dragon symbols 10m flashing intermittently and FIG. 6 shows both Dragon symbols in between flashes. A third Dragon symbol 10m remains static on the reels 12 as it is not part of the winning combination. In addition, as the table 26 indicates that only the lion symbol 10g and medal symbol 10i are activated or eligible for a winning mixed combination, and no medal symbols 10i appear on the player-selected pay lines, there is no mixed combination to award a further prize to the player.

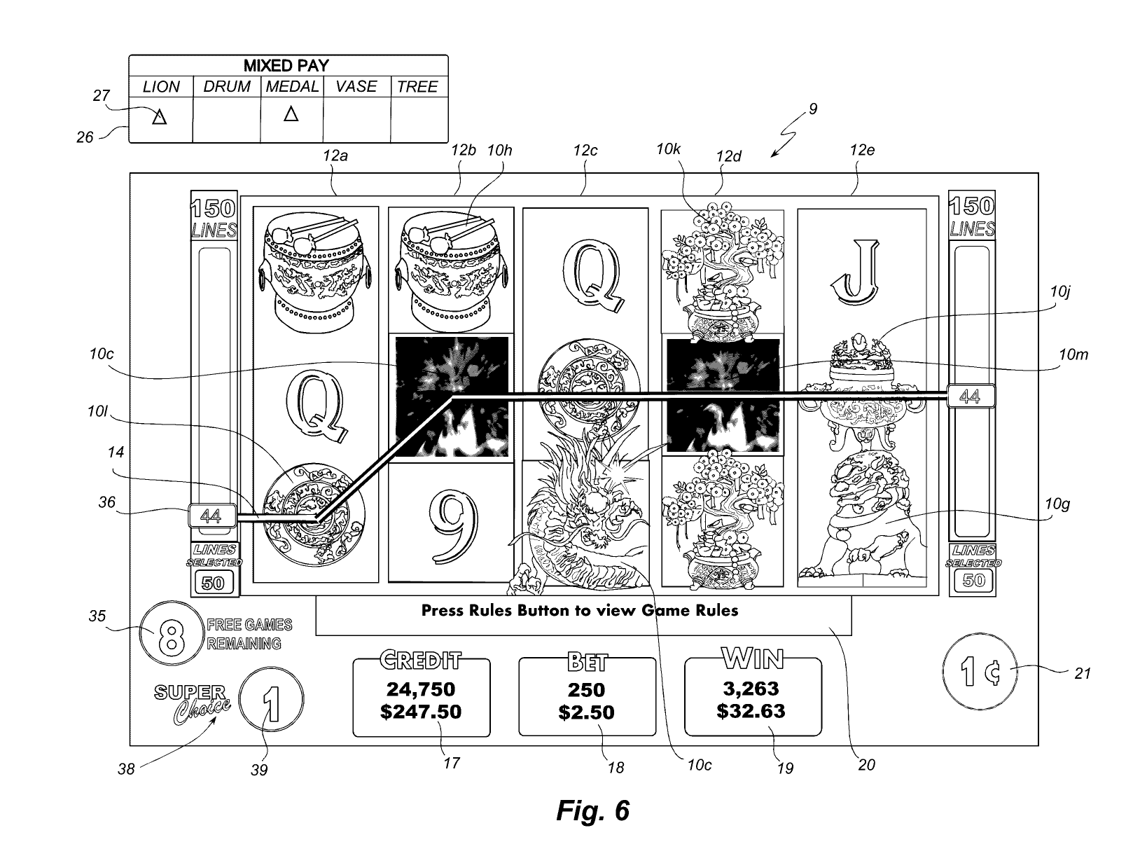

In FIG. 7, the conclusion of a spin of the base game 8 is shown, where corresponding features have been given the same reference numerals. In this spin, the player has selected the bet option of 225 credits and so has the lion symbol 10g, the drum symbol 10h and the medal symbol 10i available or activated for a mixed combination, as shown in the table 26 by arrowheads 27 indicating their availability. As such, winning mixed combinations can be formed on pay lines 40 (a group of three comprising two drum symbols 10h and one lion symbol 10g) and 41 (another group of three comprising two lion symbols 10g and one drum symbol 10h) in addition to standard winning combinations formed on pay lines 42 (four of a kind comprising two lion symbols 10g and two substitute Dragon symbols 10m) and 43 (four of a kind comprising two tree symbols 10k and two substitute Dragon symbols 10m). Thus, the player is able to obtain a greater number of winning combinations and hence prizes by selecting bet options of greater value that are associated with combinations of a greater number of unique game symbols.

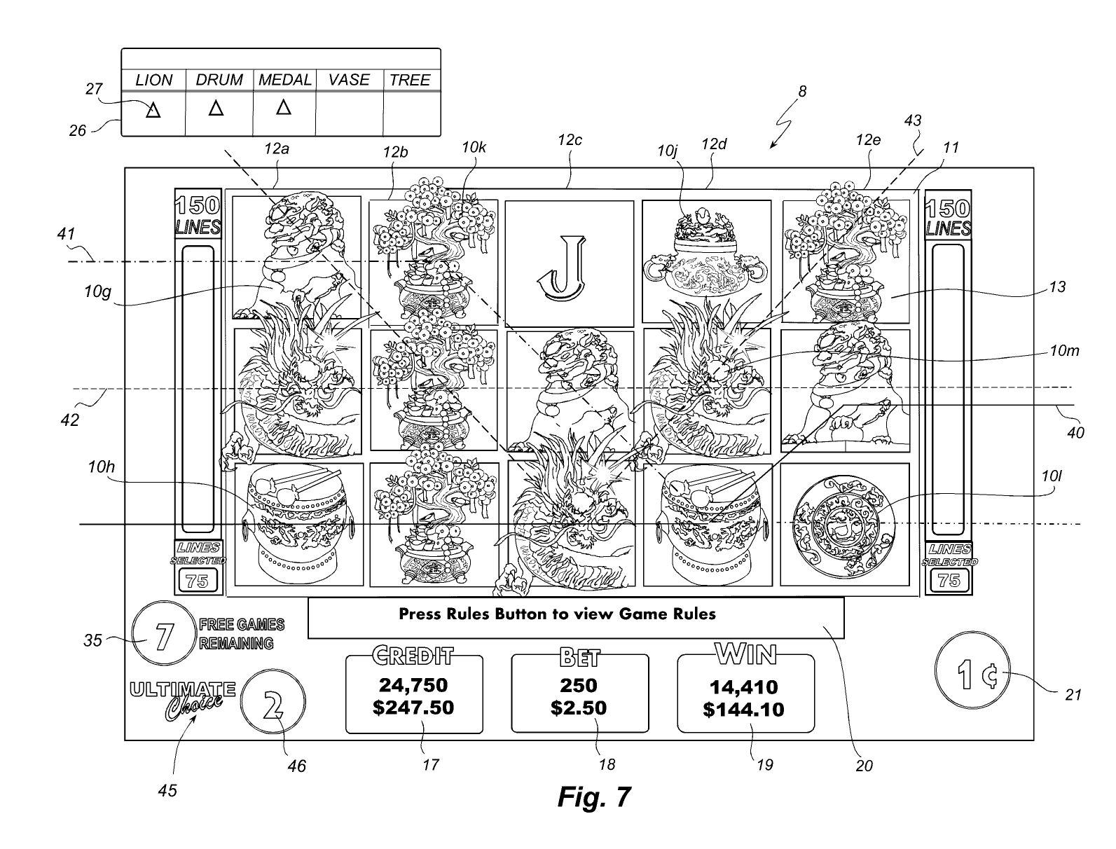

Referring to FIG. 8, where corresponding features have been given the same reference numerals, a selection screen 50 appears on the lower display area 7a of the video screen 7 displaying each bet option 55a, 55b, 55c, 55d and 55e. The selection screen 50 becomes accessible by the player once a play of the base game 8 ends via the menu screen. A message 52 is also displayed indicating that the player can choose or select one of the feature game options 55a, 55b, 55c, 55d and 55e. Bet game option 55a is the base bet option of 75 credits and does not have any mixed combinations available. Bet game option 55b is the bet option of 150 credits and has the mixed combination of two unique game symbols, being the lion symbol 10g and the medal symbol 10i. Bet game option 55c is the bet option of 225 credits and has the mixed combination of three unique game symbols, being the lion symbol 10g, the drum symbol 10h and the medal symbol 10i. Bet game option 55d is the bet option of 300 credits and has the mixed combination of four unique game symbols, being the lion symbol 10g, the drum symbol 10h, the medal symbol 10i and the vase symbol 10j. Bet game option 55e is the bet option of 375 credits and has the mixed combination of five unique game symbols, being the lion symbol 10g, the drum symbol 10h, the medal symbol 10i, the vase symbol 10j and the tree symbol 10k. Thus, the selection screen 50 informs the player that as a higher number of credits that are bet, there is an increased number of unique game symbols for use in a mixed combination. Once the player makes a selection, the electronic game controller 4 then transmits a signal to the video screen 7 to display the base game 8 in the lower display area 7a.

Thus, by selecting a bet option of increased value, the player is able to access more winning combinations of game symbols not traditionally offered by conventional gaming machines and so increases the chances of winning a prize. This increases the excitement in the player playing the base game 8 on the electronic gaming machine 1 and encourages the player to continue playing the same electronic gaming machine.

In other embodiments, the functions of the Dragon symbol 10m are divided so that there is a separate trigger symbol (which could be a scatter symbol) for triggering the feature game 9 and a separate substitute symbol used across all the games.

In other embodiments, the frequency (and thus appearance) of the designated symbols for the mixed combination may also depend on the bet option selected by the player. For example, selecting a bet option of 150 credits may make the lion symbol 10g and/or medal symbol 10i have a higher frequency of appearing on the reels 12a to 12e during play of the base game 8 and/or feature game 9, in order to increase the chance of a mixed combination appearing during game play. Selecting the maximum bet option of 375 credits makes the lion symbol 10g, drum symbol 10h, medal symbol 10i, vase symbol 10j and tree symbol 10k have a higher frequency of appearing on the reels 12a to 12e related to the game symbols 10a to 10f and 10l. This increase in frequency may also apply to the Dragon symbol 10m.

While the preferred embodiment has been described as provided a base bet option of 75 credits which is not associated or linked to a mixed combination, in other embodiments, all the selectable bet options have an associated or linked mixed combination.

In addition, as the player is able to change the selected bet option between plays of the base game 8, the table 26 also changes in response to a change in the selected bet option. For example, if the player has selected a bet option of 150 credits, the table 26 will have arrowheads 27 for the lion symbol 10g and the medal symbol 10i. If the player then changes the selected bet option to 300 credits, the table 26 will automatically update to add arrowheads for the drum symbol 10h and the vase symbol 10j. Thus, the table 26 is able to dynamically show with game symbols 10 can be used in a winning mixed combination in real-time on the screen 7.

It will also be appreciated that the game symbols 10 chosen for the mixed combinations generally have a higher value as the player selects bet options of increased value. Thus, the lion symbol 10g and medal symbol 10i have lesser intrinsic values in the base game 8 compared with the vase symbol 10j and the tree symbol 10k (based on the value of the prize awarded for a standard combination of the same game symbol; a three of a kind of the medal symbol 10i having a lower prize value than a three of a kind of the vase symbol 10j), the latter symbols only becoming available in a mixed combination for selected bet options of increased value.

In other embodiments, the player may select the game symbols 10 to be used in the mixed combination for the selected bet option. In this case, the game symbols 10 available for selection depends on a bet per game value selected by said player. This can be calculated based on the credits bet per pay line, the number of pay lines 14 selected to play or a combination of the credits bet per pay line 14 and the number of player-selected pay lines (total bet per game, which is equivalent to the selectable bet option). For example, a player selecting the bet option of maximum value (375 credits) will be able to select any of the playing card symbols 10a to 10f and picture symbols 10g to 10l to designate as being part of the mixed combination comprising five unique game symbols. In comparison, a player selecting the bet option of 150 credits will only be able to select from four of the picture symbols, say lion symbol 10g, drum symbol 10h, medal symbol 10i and vase symbol 10j, but not the other two picture symbols (tree symbol 10k and coin symbol 10l) to designate as being part of the mixed combination comprising two unique game symbols.

In some embodiments, the prizes awarded for standard combinations of three of a kind, four of a kind and five of a kind also increase with the selected bet option so that the prizes for these “pure” combinations of the same game symbol 10 are worth more than a corresponding mixed combination of a group of three, four or five. This ensures that the relative value of a pure combination pay is kept above a mixed combination.

In addition, in further embodiments, the game symbols 10 that form a mixed combination are also used for a standard combination of game symbols. For example, three tree symbols 10k on a player-selected pay line 14 can qualify for a mixed combination of a group of four with a lion symbol 10g and for a “pure” combination of three of a kind. This allows the player to “double dip” and effectively obtain multiple prizes using the same game symbols 10 on the same player-selected pay line 14.

In other embodiments, the electronic gaming machine 1 offers one or more jackpot or bonus prizes. Generally, the display screen 7 provides jackpot information relating to available jackpots or bonus prizes in the game 8. The upper display area can be used to ensure that the jackpot information is available to the player at all times during play of the base game 8 and/or feature game 9 in the lower display area 7a of the screen 7 of the electronic gaming machine 1.

In some embodiments, one or more of the mixed combinations are associated with one or more jackpot or bonus prizes. That is, the appearance of a particular mixed combination will also result in the award of a jackpot or bonus prize. For example, a mixed combination of four tree symbols 10k and one lion symbol 10g may also confer an award of a major jackpot prize in addition to the prize awarded for the mixed combination. In further embodiments, several mixed combinations may be associated with jackpot and bonus prizes. For example, a group of five comprising at least four of the same game symbol may each have an associated jackpot of differing value, based on the relative value of each game symbol 10. That is, the tree symbol 10k may have a higher intrinsic value than the vase symbol 10j (such as the standard combination of three tree symbols 10k awards a prize of 200 credits, whereas the standard combination of three lion symbols 10g awards a prize of 50 credits) and so a group of five having four tree symbols 10k will award a jackpot prize of 400 credits, compared to a group of five having four lion symbols 10g that awards a jackpot prize of 100 credits.

The jackpot or bonus prizes may include progressive jackpots, fixed jackpots, mystery jackpots and symbol driven jackpots. A progressive jackpot prize takes a portion of each bet (typically a set percentage of each bet) made on the electronic gaming machine and thus the amount of the progressive jackpot incrementally increases as more bets are made on the electronic gaming machine 1. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

The jackpot or bonus prizes may also be mystery jackpots rather than symbol driven jackpots. That is, none of the symbols in the game trigger the jackpot; hence the trigger event is a “mystery”. By way of comparison, a standard jackpot is typically symbol driven in that a particular combination of symbols must occur in the game to trigger the standard jackpot.

The trigger event for the mystery jackpot can be one randomly generated by the electronic game controller 4 for each play of the game 8. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the progressive jackpot prize. It will be appreciated that this manner of determining the trigger event may also be used to determine whether the feature game 9 is triggered in the base game 8.

Progressive jackpots can be confined to the electronic gaming machine 1 as so called “standalone” progressive jackpots. Alternatively, the jackpot is a wide area or an in-house linked progressive jackpot prize. In other embodiments, one or more the progressive jackpot prizes are configured to be part of a wide area or in-house linked progressive jackpot prize. In other words, the progressive jackpot prizes can be awarded on a group of networked gaming machines in a specified area or a group of specified electronic gaming machines that are linked together for jackpot purposes (usually via a central jackpot controller). The jackpot prizes can also be shared with any other games offered on the same electronic gaming machine 1 (as in multi-game gaming machines).

During play of the base game 8 and/or feature game 9, the electronic game controller will determine whether a trigger event for any of the jackpots has occurred, as described above. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, their values are reset and game play of the electronic gaming machine 1 continues as before. The values of the jackpots that have been won can be reset either to a predetermined start value or simply increment upwardly from zero where the won jackpot is a progressive jackpot. In addition, contributions of portions of the bet made to play the game are only made for the jackpots that are active. In this way, the player's bets do not contribute towards jackpots that the player cannot win.

In other embodiments, the in-game trigger event is determined at the end or during the play of the game; i.e. at the end or during a spin of the reels 12. In some embodiments, the in-game trigger event occurs in a preceding play of the game so that the jackpot or other result of the in-game trigger event takes place in a subsequent play of said game, typically the next play of the game after said preceding play but could include a later successive play of the game.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in said selected available jackpot set.

It will be appreciated that in other embodiments, game enhancing elements can be awarded in the feature game 9 in addition or as an alternative to the enhanced prizes awarded based on winning combinations of game symbols. The award of game enhancing elements can be done by way of a sixth reel or the appearance of game enhancing symbols in the reels 12a to 12e. A variety of game enhancing elements can be awarded by the game enhancing symbols, including:
i) symbols that award a predetermined number of free plays of said game, such as 8, 10 or 15 free spins or games;
ii) win multiplier symbols that multiply the amount of any win from one of said predetermined winning combinations;
iii) “wild” symbols that cause the display of substitute symbols in randomly selected symbol positions;
iv) bonus symbols that awards a bonus prize, either as a monetary amount or as a bonus credit;
v) wild multiplier symbols that cause the display of substitute symbols on the array 11 and multiplies the amount of any win from one of said predetermined winning combinations;
vi) bonus wild symbols that cause the display of substitute symbols on the array 11 and awards a bonus prize;
vii) symbols that cause the award of additional free plays of said game;
viii) symbols that cause one or more of said symbol positions to be held static (typically one or more reels 12a to 12e) and display substitute symbols on the array 11;
ix) symbols that cause the same game symbol to be stacked in a group of symbol positions, typically the group being one or more reels 12a to 12e;
x) symbols that cause the display of new game symbols on the array 11;
xi) “reveal” symbols that cause a game symbol to reveal another game symbol;
xii) “replacement” symbols that cause one or more game symbols to be replaced by other game symbols in the array 11;
xiii) bonus prize of 5× bet, 10× bet or 25× bet (the total amount of the bet or credits bet per pay line);
xiv) all royal card symbols change to wilds (substitute symbols) on reels 12b, 12c and 12d (usually called reels 2, 3 and 4, respectively) of the array 11;
xv) all picture symbols change to wilds on reels 2, 3 and 4 of the array 11;
xvi) all symbols on reels 2 and 4 of the array 11 change to wild symbols; and
xvii) all symbols on reels 12a and 12e (usually called reels 1 and 5, respectively) of the array 11 change to wild symbols.

These game enhancing symbols do not modify the function or value of the game symbols 10 that appear on the array 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

In other embodiments, the game enhancing symbols include “collector”-type game enhancing symbols which award points or tokens. The collection of points or tokens during the base game 8 and/or feature game 9 leads to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

While the same game format is essentially used across the base game 8 and feature game 9, it will be appreciated that the game format may vary across the base and feature games, as well as between base games where more than one game is offered by the same electronic gaming machine 1. For example, one of the games 8 may be a wheel-type game or a four reel game and another of the games may be a standard five reel game. Similarly, the games 8 may each have different game symbols, game rules and pay tables that are unique to each game.

While one embodiment of the invention has been described in relation to a base game 8 and a feature game 9, it will be appreciated that the invention could include one or more additional feature games that are triggered by specific trigger symbols appearing in the feature game 9. Also, the additional feature games may also have trigger symbols that trigger further feature games in a cascading fashion. These additional and further feature games could have the same game play elements as the feature game 9 or be different feature games entirely.

Also, in the preferred embodiment, the mixed combinations are available in the base game 8 and the feature game 9. However, in other embodiments, the mixed combinations are only available in the base game 8. In a further embodiment, the mixed combinations are only available in the feature game 8. Where the feature game 9 also comprises trigger symbols for triggering further feature games, then the mixed combinations can be either available or not available for some or all of these cascading feature games.

Furthermore, the embodiments of the invention have been described as providing a standard 5×3 set of reels 12 for the base game 8. However, it will be appreciated that in other embodiments, the size and shape of the reels 12 may vary for both the base game 8 and the feature game 9. For example, the array 11 could take any number of different shapes, such as triangular, circular, square, hexagonal, hemi-spherical or other non-rectangular or polygonal shapes. In another example, where the array is circular, the symbol positions 13 can take the form of pie-shaped slices or wedges. Alternatively, the array 11 could have an unequal number of rows and/or columns. For example, the reels 12a, 12b could have three rows, but the reels 12c to 12e could have four rows.

In other embodiments, the base game 8 and the feature game 9 need not be displayed on a single video screen 7. Instead, they may be displayed on separate video screens, with the lower display area 7a appearing in a lower video screen and the upper display area on an upper video screen. Also, the order can be reversed, with the base game 8 and/or feature game 9 appearing on an upper video screen or upper part of a single video display screen 7 and the information usually shown on the upper display area appearing on a lower video screen or lower part of a single video display screen.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the electronic gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12.

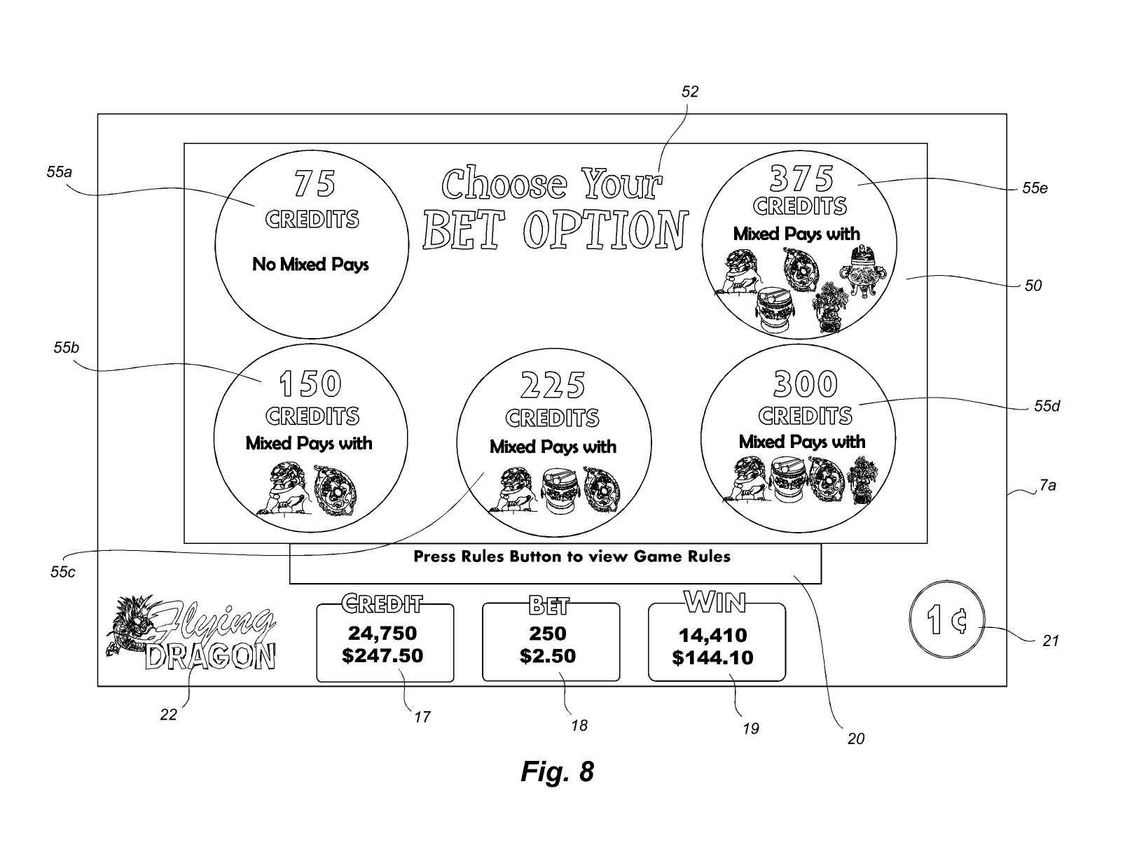

Referring to FIG. 9, another embodiment of the invention is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 2000 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the player's gaming habits, etc.

The electronic gaming machine 200 may include one or more audio speakers 262, a coin payout tray 264, an input control panel 266, and a color video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

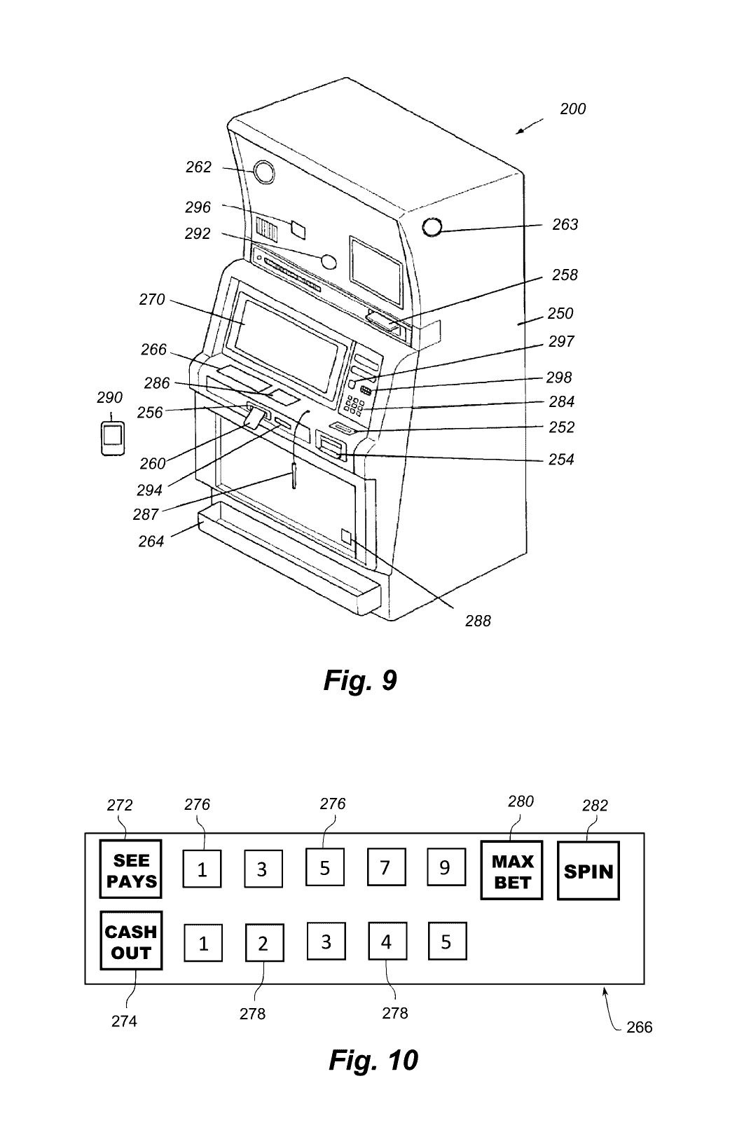

FIG. 10 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 10, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a colored area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

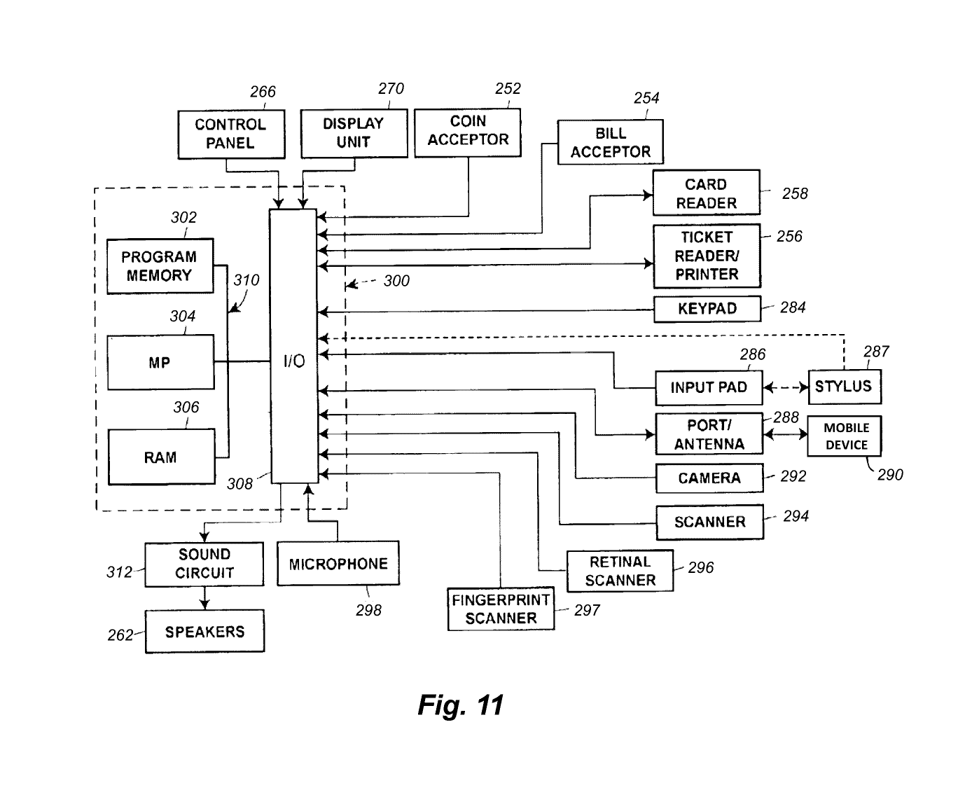

FIG. 11 is a block diagram of a number of components that may be incorporated in the electronic gaming machine 200. Referring to FIG. 11, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 11 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 11, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 11 may be connected to the I/O circuit 308 via a common bus or other data link that is shared by a number of components. Furthermore, some of the components may be directly connected to the microprocessor 304 without passing through the I/O circuit 308.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer programme configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory computer readable or carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the reels 12 and the feature of providing separate video screens for the lower display area 7a and upper display area can be combined into a single electronic gaming machine 1. Similar combinations of two or more features from the above described embodiments or embodiments of the invention can be readily made by one skilled in the art.

By providing selectable bet options that provide winning combinations comprising a mixture of two or more unique game symbols in addition to standard winning combinations containing only one type of game symbol, the invention provides a variety of game play that is not found in other standard electronic gaming machines and thus stimulates interest in a player. This is enhanced by changing the number of unique game symbols that can form a winning mixed combination based on the selected bet option, with a greater number of unique symbols being provided with selected bet options of higher value. In addition, the player is able to customise game play on the electronic gaming machine to fit his or her comfort level in balancing the “risk vs. reward” in making bets of higher value for increasing the probability of obtaining winning combinations and/or prizes of higher value. All these advantages of the invention result in the player being more likely to retain interest in continuing to play the same electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine, comprising:
a display for displaying a game, wherein said game comprises game symbols arranged in an array of symbol positions and where predetermined winning combinations of randomly selected game symbols award prizes to a player; and
an electronic game controller in electronic communication with said display for controlling the appearance of game symbols in said game on said display; and
a value transfer mechanism for receiving value from a player to make a bet and initiate play of said game on said display, said value transfer mechanism being in electronic communication with said electronic game controller;
wherein said electronic game controller in response to said player making a bet via said value transfer mechanism commences play of said game by randomly selecting game symbols and transmitting a signal to said display to display said randomly selected game symbols;
wherein said electronic game controller enables said player to select a bet option from a plurality of bet options for said game, two or more of said bet options being associated with a combination of two or more unique game symbols and at least two bet options being associated with different combinations of said unique game symbols; and
wherein said player selects one of said bet options and, in response to said selection, said electronic gaming machine awards a prize for said combination of said two or more unique game symbols associated with said selected bet option when said combination appears in a play of said game.

2. The electronic gaming machine of claim 1, wherein said plurality of bet options further comprises a bet option that is not associated with a combination of two or more unique game symbols.

3. The electronic gaming machine of claim 1, wherein one of said associated bet options is associated with a combination of at least three unique game symbols.

4. The electronic gaming machine of claim 1, wherein one of said associated bet options is associated with a combination of at least four unique game symbols.

5. The electronic gaming machine of claim 1, wherein one of said associated bet options is associated with a combination of at least five unique game symbols.

6. The electronic gaming machine of claim 1, wherein the number of unique game symbols in said combinations associated with said associated bet options increases as the value of the selected bet option increases.

7. The electronic gaming machine of claim 1, wherein said game comprises a base game and a feature game, and prizes are awarded in said base game and said feature game for said combination of unique game symbols associated with said selected bet option.

8. The electronic gaming machine of claim 1, wherein said unique game symbols in said combination associated with said selected bet option are dynamically shown on said display.

9. The electronic gaming machine of claim 1, wherein said unique game symbols in said combination associated with said selected bet option are selectable by said player from a group of unique game symbols.

10. The electronic gaming machine of claim 9, wherein said unique game symbols available in said group depend on a bet per game value selected by said player.

11. The electronic gaming machine of claim 1, wherein one of said combinations of unique game symbols associated with at least one of said associated bet options is also associated with a jackpot prize awarded by said electronic gaming machine.

12. The electronic gaming machine of claim 1, wherein at least one of said unique game symbols can form a predetermined winning combination comprising only of a predetermined number of said at least one unique game symbol and form said combination of two or more unique game symbols.
